(19) United States
(12) Patent Application Publication
(10) Pub. No.: US 2005/0064066 A1
(43) Pub. Date: Mar. 24, 2005

(54) Alcoholic beverage

(75) Inventor: Steve Ramsden, Muscatine, IA (US)

Correspondence Address: BANNER & WITCOFF, LTD., TEN SOUTH WACKER DRIVE, SUITE 3000, CHICAGO, IL, 60606, US

(73) Assignee: Grain Processing Corporation, Muscatine, IA (US)

(21) Appl. No.: 10/913,817

(22) Filed: Aug. 6, 2004

Related U.S. Application Data
(60) Provisional application No. 60/494,011, filed on Aug. 7, 2003.
(60) Provisional application No. 60/574,731, filed on May 27, 2004.

(51) Int. Cl. C12C 11/00

(52) U.S. Cl. 426/11

(57) ABSTRACT

Disclosed is an alcohol mixture that comprises a product of fermentation that is treated with calcium under conditions suitable to precipitate sulfurous proteinaceous material. The invention also provides a method of producing a blended fermented beverage from a calcium-precipitated fermented beverage and a starch hydrolyzate fermented beverage. The calcium-precipitated fermented beverage or blended beverage may be further treated to decolor the beverage (such as via activated carbon treatment) and, if desired, further treated to reduce the level of other undesirable components.

### RELATED APPLICATIONS

This application claims priority to Application Ser. No. 60/494,011, filed Aug. 7, 2003, and Application Ser. No. 60/574,731, filed May 27, 2004. Both prior applications are hereby incorporated by reference in their entireties.

### FIELD OF THE INVENTION

This invention pertains to fermented beverages and methods of producing same.

### BACKGROUND OF THE INVENTION

The prior art has provided innumerable varieties of fermented and distilled alcoholic beverages. Beer and wine are generated by fermenting sugars found in or derived from grain- or fruit-based mashes or musts. Distilled spirits also are generated from fermentation of a mash, but undergo subsequent distillation to increase the alcohol content, and, in most cases, to modify the flavor, color, and aroma of the product. Most distilled products are aged to further modify flavor, aroma, and color.

Generally, in the art of fermented alcoholic beverages, efforts are made to impart flavor to or enhance flavors in the finished product. For example, beers are produced using carefully selected starting materials, e.g., combinations of barley, wheat, hops, and the like, which impart distinctive flavors and aromas to the finished product. Brewers take steps to enhance the flavor of the beer, for instance by toasting the barley malt used to prepare the beer, by selecting other germinated grains (e.g. wheat) and by selecting other ingredients (in particular hops) to add flavor to the beer. In winemaking, vintners will vary the fruit must, the fermentation parameters, and the vessels used for storing and aging the wine. Wines are generally allowed to ferment for a lengthy period (7-21 days) to allow the wines to develop complex flavor-and aroma-producing components. Through such techniques, a variety of wines with an infinitely complex spectrum of flavors and aromas may be produced. In the case of distilled spirits other than grain neutral spirits, the fermentable starting material has an enormous impact on the flavor and character of the distilled beverage, as does the type of vessel selected for storing and aging the spirits.

All of the foregoing procedures and operating parameters are designed to add or modify flavor-and aroma-generating components in the beverage. In the fermented beverage arts, occasionally efforts are made to provide a colorless and flavorless product. Such products can be sold “as is,” or flavoring agents subsequently can be added to provide a flavored beverage. Recently, there has been a growing consumer interest in neutral beverages that have been flavored with citrus or other non-grain flavorings.

It has long been known in the art to provide a clear, flavorless beverage via distillation of a fermented alcoholic mixture to the eutectic point of the mixture, followed by filtration and decolorization of the resulting product. The resulting distilled beverage, termed a “grain neutral spirit,” is sold at commodity levels for various uses in the beverage industry. Although such distilled neutral-tasting beverages are often commercially acceptable, distillation is not appropriate under all circumstances. Distillation is costly and time intensive, and increases the alcohol-content of the product, thus requiring dilution if a lower alcohol content is desired. In addition, beverages containing distilled spirits are treated differently from fermented beverages for tax purposes.

In an effort to keep up with consumer demand for new products, and in a socially responsible effort to provide beverages with a low alcohol content (under about 9%), the beverage industry has introduced numerous neutral alcoholic beverages that are prepared by methods other than distillation. For example, U.S. Pat. No. 4,990,350 purportedly describes a beverage having a reduced alcohol content that is said to be produced without dilution of distilled spirits. Many efforts have been made to prepare a neutral-tasting beverage from malted barley (malt). For instance, U.S. Pat. No. 5,294,450 purportedly describes a colorless malt beverage product that is said to minimize consumer sensations of fullness and to provide attractive taste characteristics. The prior art reflects numerous efforts to supplement the malt with carbohydrate adjuncts and to ferment the malt/adjunct mixture under controlled conditions to yield a neutral beverage or beverage base. For instance, U.S. Pat. No. 4,495,204 describes a neutral-tasting beverage made from malt and dextrose. U.S. Pat. No. 3,798,331 describes an alcoholic beverage made from malt, sucrose, and soya flakes. U.S. Pat. No. 3,332,779 discusses the preparation of a neutral beverage prepared from malt and glucose. U.S. Pat. No. 4,021,580 describes preparation of a neutral beverage from malt and corn syrup. Other adjuncts are described in U.S. Pat. No. 3,908,021.

Notwithstanding the foregoing, there remains room for improvement over the heretofore described art. The foregoing non-distilled beverages are believed to have a characteristic malt-like flavor. Techniques of purifying fermented products, such as ultrafiltration (see, e.g., U.S. Pat. No. 5,439,699) have been proposed, but such techniques have proven inefficient or unsuccessful in providing the desired flavor-neutral alcoholic product.

In view of the above, the invention seeks to provide in preferred embodiments a fermented, non-distilled beverage that is colorless, flavorless and odorless.

### THE INVENTION

The invention provides an alcoholic beverage and a method for preparing an alcoholic beverage. More specifically, the invention provides a fermented beverage, and a method for preparing a fermented beverage. In preferred embodiments, the beverage is colorless, flavorless, and odorless, and organoleptically neutral.

It has been found that a fermented alcoholic mixture, such as distiller's corn mash, may be used to prepare an alcoholic beverage. Such mixtures often are not well suited for drinking; for instance, as a direct product of fermentation, the distiller's corn mash contains many undesirable components and has a brownish color that may not be acceptable in some beverage applications. Distiller's corn mash also is turbid and has an unpleasant sulfurous flavor or odor, both of which properties render the product unacceptable in the many beverage applications.

Generally, in accordance with the invention, an alcoholic mixture that comprises a product of fermentation is treated with calcium under conditions suitable to precipitate sulfurous proteinaceous material. It is believed that such material is responsible for haze formation in fermentation products, and is at least partially responsible for the sulfurous flavor of such alcoholic mixtures. Although it is contemplated that other forms of calcium treatment may be effective, surprisingly, treatment with calcium hydroxide is effective to precipitate at least a portion (and preferably essentially all) of the sulfurous proteinaceous material to thereby leave an alcoholic beverage that is clear and that, in preferred embodiments, is substantially devoid of sulfurous odors and flavors. Most preferably, the beverage has essentially no flavor, or has a neutral flavor. The beverage may be further treated to decolor the beverage (such as via activated carbon treatment) and, if desired, further treated with an ion exchange resin to reduce the level of other undesirable components.

A fermented beverage prepared as heretofore discussed is itself a commercially valuable product. Generally, to prepare a product that is suitable for end user consumption, the fermented beverage is subjected to carbon filtration to substantially remove yeast flavors, thereby resulting in a remaining mixture. The remaining mixture is then subjected to ion exchange filtration to substantially remove salts and organic acids from the remaining mixture. If desired, coloring or flavoring agents may be added. A fermented beverage prepared in accordance with the inventive method also is provided.

The present application also contemplates in some embodiments a blend of a calcium-precipitated fermented beverage with a starch hydrolyzate fermented beverage. The starch hydrolyzate fermented beverage may be prepared by providing a starch hydrolyzate and fermenting the starch hydrolyzate in the presence of yeast, a soluble nitrogenous yeast nutrient source, and an enzyme that releases fermentable carbohydrates from the starch hydrolyzate to thereby provide a fermented beverage. The carbohydrate should consist essentially of free glucose and saccharide oligomers.

It is believed that the starch hydrolyzate fermented beverage will have outstanding organoleptic properties, and can be made to be essentially completely colorless, flavorless, and odorless. The calcium-precipitated fermented beverage, particularly that prepared from a distiller's corn mash, possesses very good organoleptic properties. In preferred embodiments, the calcium-precipitated fermented beverage may be prepared more economically than the starch hydrolyzate fermented beverage. The calcium precipitated fermented beverage may be blended with the starch hydrolyzate fermented beverage to achieve a desired combination of organoleptic properties and economy of preparation. It is contemplated that the beverages may be blended either before or after post-fermentation treatments such as decolorization with carbon and ion exchange treatment.

Features of the preferred embodiments of the invention are described hereinbelow.

### DETAILED DESCRIPTION OF THE PREFERRED EMBODIMENTS

The invention is predicated, at least in part, on the desire to produce a non-distilled, fermented beverage that is colorless, flavorless, and odorless, and organoleptically neutral, i.e., lacking in distinctive character, aroma, odor, or taste. The present application contemplates a calcium-precipitated fermented beverage, as described herein below. In some embodiments, the invention contemplates a blend of a calcium-precipitated fermented beverage with a starch hydrolyzate fermented beverage.

In preferred embodiments, the fermented beverage has the organoleptically neutral properties of a distilled grain neutral spirit that has been diluted with distilled water to the same alcohol content as the fermented beverage. In accordance with some embodiments of the invention, the fermented beverage can be modified after preparation to add flavorings and color and, if desired, to increase alcohol content. It is even possible in some embodiments of the invention that the fermented beverage is itself subject to distillation, although distillation is deemed unnecessary and hence undesired.

The calcium-precipitated fermented beverage may be prepared by any suitable techniques and from any suitable starting material. Generally, a fermented alcoholic mixture, such as distiller's corn mash, may be used to prepare an alcoholic beverage. Such mixtures often are not well suited for drinking; for instance, as a direct product of fermentation, the distiller's corn mash contains many undesirable components and has a brownish color that may not be acceptable in some beverage applications. Distiller's corn mash also is turbid and has an unpleasant sulfurous flavor or odor, both of which properties render the product unacceptable in many beverage applications.

To prepare the calcium-precipitated alcoholic beverage, generally an alcoholic mixture which comprises a product of fermentation (such as distiller's corn mash) is treated with calcium under conditions suitable to precipitate sulfurous proteinaceous material. It is believed that such material is responsible for haze formation in fermentation products, and is at least partially responsible for the sulfurous flavor of such alcoholic mixtures. Although it is contemplated that other forms of calcium treatment may be effective, surprisingly, treatment with calcium hydroxide is effective to precipitate at least a portion (and preferably essentially all) of the sulfurous proteinaceous material to thereby leave an alcoholic beverage that is clear and that, in preferred embodiments, is substantially devoid of sulfurous odors and flavors. Most preferably, the beverage has essentially no flavor, or has a neutral flavor. The beverage may be further treated to decolor the beverage (such as via activated carbon treatment) and, if desired, further treated with an ion exchange resin to reduce the level of other undesirable components. These treatments may be performed before or after blending with the starch hydrolyzate fermented beverage.

Calcium treatment is contemplated to be useful in connection with any product of fermentation that is suitable for use in connection with a comestible alcoholic beverage. Preferably, for cost reasons, distiller's corn mash is used. This material is the starting mash (or “beer”) used by distillers to prepare grain neutral distilled spirits, and typically is formed from a heterogeneous mixture of corn products, such as starch, protein, and so forth that has been enzymatically converted to fermentable carbohydrates and fermented with a suitable yeast. Typically, a conventional distiller's yeast is used to ferment this mixture to thereby form distiller's corn mash. Unlike traditional malt beverage fermentations, the distillery mash fermentations are rapid (two to three days), at much higher temperatures (85° to 90° F.) and produce much higher alcohol concentrations (8-18% by volume). Even after removal of yeast and particulate matter, this leaves an alcoholic mixture that is very turbid and that smells of sulfur. The typical malt flavors and odors that accompany conventional malt beverages are generally not observed in connection with such alcoholic mixtures; such flavors and odors are often desired in other applications, but are deemed undesirable in connection with the present invention.

The invention is not limited to the treatment of distiller's corn mash, but to the contrary any other product of fermentation (e.g. rice, barley, etc.) may be employed. In some embodiments of the invention, the fermented material may even be the product of fermentation of a starch hydrolyzate, such as that described in copending application Ser. No. 10/803,348 (Ramsden, assigned to Grain Processing Corporation of Muscatine, Iowa), if such product of fermentation contains sulfurous proteinaceous material that is amenable to precipitation with calcium. In any event, the alcoholic mixture preferably is obtained commercially or from a commercial distillery operation. The invention contemplates in some embodiments the steps or providing a fermentable material and fermenting the material to produce a fermented alcoholic mixture.

The alcoholic mixture generally is centrifuged or filtered, if necessary, to remove yeast and particulate matter. Next, the mixture is treated with calcium under conditions effective to precipitate at least a portion of the sulfurous proteinaceous material in the mixture. Generally, the mixture should be treated with calcium hydroxide, such that the pH ranges from pH 5 to pH 8, more preferably, pH 6 to pH 7, and most preferably, a pH of 6.2. It has been found that from 3-4 g of calcium hydroxide per liter of alcoholic mixture is often sufficient. The proteinaceous material itself is not well defined, but is believed to comprise peptides, proteins, and oligopeptides of various chain lengths and molecular weights. The sulfur in the proteinaceous material is believed to be at least partially responsible for the sulfurous flavor and odor of typical distillation mashes, although other sulfurous compounds are associated with the proteinaceous compounds and are also believed to contribute to sulfurous flavor and odor. The invention should not be deemed limited to any particular theory of operation, and irrespective of how the sulfurous flavors and odors arise, it has been found that the calcium treatment described herein may be employed to substantially remove such sulfurous flavors and odors. Although the mechanism of precipitation is not fully understood, it is believed that the proteinaceous material forms a complex with calcium at the pH levels specified herein.

Preferably, the mixture is stirred for 5-15 minutes at ambient temperature, then filtered (e.g. Whatman #1 filter paper) to remove the precipitated proteinaceous material. The resulting product is non-turbid, and is substantially free of sulfurous odors and flavors. This product may be used as a beverage, or may be further treated or used as a base in connection with the preparation of other alcoholic beverages. In conjunction with the present invention, this product is blended with a starch hydrolyzate fermented beverage.

If desired, the product may be decolored, by which is contemplated the substantial or complete removal of components which cause color formation. Any suitable decoloring procedure may be employed in connection with the invention. Preferably, the beverage is treated with activated carbon by adding 5-30 g activated carbon per liter of beverage, with stirring for 5-15 minutes at ambient temperature followed by filtration (e.g. through Whatman #1 filter paper). In preferred embodiments, this decolored beverage is an excellent neutral beverage or base for other alcoholic drinks.

If desired, the beverage may be further treated. For instance, the beverage may be treated with an ion exchange resin in a manner effective to reduce the levels of other undesirable components, such as ash (salts), organic acids, or other flavor or color components. Any suitable cationic, anionic, or mixed bed resin may be employed, and any suitable batch or continuous process may be employed. Any suitable commercially available resin or other resin as may be found suitable may be employed in connection with the invention. In some embodiments, 100 g of mixed bed ion exchange resin is added per liter of beverage, with stirring for 10 minutes and filtration (e.g. through Whatman #1 filter paper). If further desired, an additional carbon treatment (e.g. 1.5 g carbon per 200 ml beverage) with stirring for 10 minutes and filtration through Whatman #1 filter paper may be employed. The methods and procedures described herein may be varied, and indeed any suitable procedures may be employed.

After treatment with calcium, and before or after the subsequent treatments and before or after blending with a starch hydrolyzate fermented beverage, a flavoring agent may be added to the beverage. In this embodiment flavoring agents are deemed to include sweeteners, such as sugar and corn syrup, as well as innumerable other agents (e.g. citrus agents, fruit flavorings, mint flavorings, and any other flavoring agent desired).

In accordance with some embodiments of the invention, the calcium-precipitated fermented beverage may be blended with a starch hydrolyzate fermented beverage, such as that taught in copending application Ser. No. 10/803,348 (not prior art to the present application). Starch hydrolyzates are employed in accordance with these embodiments of the invention as a source of fermentable carbohydrates in the preparation of a starch hydrolyzate fermented beverage. The starch hydrolyzate consists essentially of free glucose and saccharide oligomers, with little starch present and with as low an amount of other grain components present as is practicable. Most fermentations described in the prior art employ starch, which is hydrolyzed in situ in the germinated grain or which is added as an adjunct. In accordance with the invention, at least 95% and preferably 100% of the carbohydrate content of the fermentation mixture is present in free form, with little or no other grain components being present.

In general, the starch hydrolyzate is a hydrolysis product of granular starch, preferably a maltodextrin, and most preferably a maltodextrin from which fat and ash present in the granular starch have been removed. The soluble nitrogenous yeast nutrient source preferably is a yeast nutrient source that, when used in the fermentation, results in a product that is as organoleptically neutral as possible. The nutrient source preferably is present in an amount sufficient to sustain fermentation of the starch hydrolyzate to an alcohol concentration that renders fermenting yeast inactive in a manner such that the yeast nutrient source is not rate limiting in the fermentation reaction. The method can comprise selecting for fermentation appropriate amounts of a starch hydrolyzate, yeast, an enzyme that releases fermentable carbohydrates from the starch hydrolyzate, and a soluble nitrogenous yeast nutrient source.

It is contemplated that in most cases the starch will have been hydrolyzed via acid or enzymatic catalysis. Such products are composed of 90% or more, preferably 95% or more, and most preferably 98% or more by dry solids weight glucosidic units (which in the context of the present invention is deemed to include both glucose and saccharide oligomers). In preferred embodiments, fat and ash have been removed from the starch hydrolyzate to yield a product that is composed of at least 99% and preferably essentially of 100% glucosidic units by dry solids weight, with essentially no other grain component being present. In highly preferred embodiments, the source of fermentable material consists essentially of a mixture of glucose and saccharide oligomers, the oligomers being α-1-4 or α-1-6 linked glucosidic oligomers. Generally, the starch hydrolyzate used in conjunction with the invention is itself not directly fermentable, or is only partially fermentable. Only those saccharides in the mixture that have a degree of polymerization (“DP”) of 3 or less are deemed to be susceptible to fermentation. Such starch hydrolyzates are generally known in the art and are available commercially, and include, for example, maltodextrins and syrup solids. The starch hydrolyzate ideally has a dextrose equivalent (DE) of about 4 to about 70, preferably, a DE of about 10 to about 70 (e.g., a DE of about 10, about 20, about 30, about 40, about 50, or about 60).

Preferred starch hydrolyzates are available commercially from Grain Processing Corporation of Muscatine, Iowa under the MALTRIN® trademarks. These include maltodextrins such as MALTRIN® M040 (DE=4), MALTRIN® M050 (DE=5), MALTRIN® M100 (DE=10), MALTRIN® M150 (DE=15), and MALTRIN® M180 (DE=18), and syrup solids such as MALTRIN® M200 (DE=20) and MALTRIN® M250 (DE=25). The MALTRIN® products are themselves substantially bland in flavor and consist essentially of mixtures of glucose and α-1-4 linked glucosidic oligomers from which fat and ash has been substantially removed. These products are composed of greater than 99.5% glucosidic units. Maltodextrins are highly preferred for use in conjunction with the invention, and the most highly preferred maltodextrins include MALTRIN® M100 and M180. Other starch hydrolyzates (including blends and including sugar syrups and limit dextrins) may be used in conjunction with the invention.

Previous methods of producing fermented beverages include providing whole grain mashes as a carbohydrate source. Such grain mashes preferably are not used in conjunction with the preparation of a starch hydrolyzate fermented beverage, because fermentation of such mashes will result in a product with a grain-like flavor. The heretofore described starch hydrolyzates yield starch hydrolyzate fermented beverages that have a cleaner finish than may be attained using whole-grain carbohydrate sources.

The starch hydrolyzate preferably is present in an amount of about 20% to about 25% solids (w/v) in an aqueous fermentation broth. The precise amount of starch hydrolyzate for inclusion in the fermentation reaction is easily determined by the practitioner and is dependent on the parameters of the fermentation reaction, such as the volume of the fermentation broth, the desired alcohol content of the final fermented beverage product, and the amounts of yeast and enzyme. The amount of starch hydrolyzate is ideally that which allows consumption of the carbohydrate thereby resulting in an alcohol content that is within 1% (absolute) of the inactivating alcohol concentration for the particular yeast used in connection with the fermentation reaction. Those skilled in the art will be able to determine the quantity of carbohydrate used in connection with this preferred embodiment. In other embodiments, a greater or lesser amount of carbohydrate may be employed. If a lesser amount of carbohydrate is employed, the fermentation will stop abruptly, thus leading to an alcoholic beverage with a lower alcohol content than is desired in preferred embodiments. A greater amount of carbohydrate may be employed if it is desired to impart the beverage with sweetness and/or carbohydrate “body” after fermentation.

The yeast employed to produce the fermented beverage can be any strain of yeast that ferments the carbohydrates released by starch hydrolyzate to form alcohol. The yeast preferably does not produce byproducts which impart flavor or odor to the fermented beverage. Preferably, the yeast is a baker's yeast (i.e., a leavening yeast). The fermentation of carbohydrates by known brewer's yeasts, commonly used in beer production, can result in undesired taste components that are difficult to remove from the finished fermented beverage. For this reason, such yeasts are not deemed to be preferred. Use of baker's yeast, such as a suitable species of Saccharomyces (e.g., Red Star commercial baker's yeast), most preferably S. cerevisiae, is believed to minimize unwanted flavor contamination. The yeast can be grown aerobically in a medium similar to the fermentation broth using standard culture techniques, and added to the fermentation broth at an innoculum rate of about 1% to about 20% (v/v) (e.g., about 5% to about 10% (v/v)). Using such yeasts, it has been found that an alcohol concentration of approximately 10% to approximately 15% is inactivating. Other yeasts may remain active until higher alcohol concentrations are reached.

To achieve the desired taste-neutral fermented beverage product, the parameters of the fermentation reaction are selected so as not to stress the yeast. Stress responses in yeast are believed to result in the production of byproducts that impart unwanted flavor to the fermented beverage. For this reason, a nitrogenous yeast nutrient source also is provided in the fermentation broth. The nitrogenous yeast source is present for the purpose of sustaining health and allowing growth of the yeast during the fermentation reaction. In accordance with the invention, an amount of soluble nitrogenous yeast nutrient source is selected to ensure robust health of the yeast during the fermentation. In accordance with preferred embodiments of the invention, the yeast source is present in an amount sufficient to allow the yeast to achieve an inactivating alcohol concentration and such that the yeast nutrient source is not rate limiting during the fermentation. It is believed that the inclusion of lesser amounts of yeast nutrient source will cause the yeast to produce by-products (such as fusel oils) that can adversely affect the organoleptic properties of the fermented beverage. The amount of nitrogenous yeast nutrient source provided in the fermentation broth generally should be about 0.1% to about 5.0% (w/v) (e.g., preferably about 0.5% to about 3.0% (w/v)). The particular amount of nitrogenous yeast nutrient source may be determined by the practitioner based on the desired characteristics of the fermentation product.

In preferred embodiments, the nitrogenous yeast nutrient source is itself bland, and does not contribute significant levels of undesired flavor and odor components to the fermentation mixture. Most preferably, the yeast nutrient source is composed of at least 80% nitrogenous material, more preferably, at least 85%, more preferably, at least 90% and more preferably still, at least 95% nitrogenous material by dry solids weight. In conventional production of grain neutral spirits, corn steepwater frequently is employed as a nitrogenous yeast source. The nitrogenous content of corn steepwater typically ranges from 45-50% by dry solids basis, with the remaining components including sulfurous materials, phytic acid, lactic acid, ash, and other materials deemed undesirable in the context of the invention. Corn steepwater is malodorous and contributes significantly to flavor and odor of the fermentation mixture. This is not deemed to be a concern in the preparation of grain neutral spirits, because flavor and odor components of steepwater are substantially eliminated upon distillation. Because the invention seeks to provide a neutral beverage without the need for distillation, in accordance with the present invention, steepwater should not be used. To the contrary, in accordance with preferred embodiments, a nitrogenous yeast nutrient source that is organoleptically more neutral than corn steepwater from a commercial wet milling operation should be used.

The nitrogenous yeast nutrient source provides nutrients for yeast cells. Generally, the yeast extract should contain amino acids sufficient to sustain yeast growth without stressing the yeast. Although yeast is able to synthesize amino acids from nitrogenous sources, such synthesis often yields fusel oils and other undesirable byproducts which can adversely affect the organoleptic properties of the fermented beverage. For this reason, the yeast source should provide a sufficiently diverse profile of amino acids to minimize the formation of fusel oils in the fermented product. Ideally, the yeast nutrient source is a source of all of the amino acids normally required or synthesized by the yeast. In any event, the yeast nutrient source should contain a sufficient quantity and variety of amino acids such that the yeast nutrient source is not rate limiting in the fermentation reaction.

In highly preferred embodiments, the nitrogenous yeast source comprises the soluble fraction of hydrolyzed yeast (i.e., yeast extract). Yeast extract is believed to contain all of the amino acids required by the yeast to avoid rate-limiting phenomena in the fermentation reaction. Suitable yeast extract is available commercially from Red Star. Casein hydrolyzate also is a suitable soluble nitrogenous yeast nutrient source, as are certain vegetable extracts (e.g. soy extract).

The starch hydrolyzate generally will not be readily fermented by yeast. Accordingly, an enzyme is provided to break down the starch hydrolyzate into fermentable sugars. Appropriate enzymes for use in the inventive method cleave fermentable carbohydrate molecules (DP less than or equal to 3) from the starch hydrolyzate and are stable at the temperatures at which the fermentation reaction occurs. Preferably, the enzyme cleaves α-1,4 and/or α-1,6 oligosaccharide linkages in the starch hydrolyzate. Glucoamylase (available from Genencor International) releases glucose subunits from starch hydrolyzates and, accordingly, is useful in the context of the inventive method. Likewise, β-amylase, which cleaves maltose subunits leaving β-linked dextrins, and maltotriose-cleaving enzymes, which cleave maltotriose leaving limit dextrins, can be provided in the fermentation broth. If a β-amylase enzyme or a maltotriose-cleaving enzyme is employed, such are preferably used in conjunction with a starch debranching enzyme, such as pullulanase, to avoid leaving limit dextrin which would contribute to body in the fermented beverage. Multiple enzymes can be provided to efficiently generate fermentable sugars. The enzyme is preferably added in substantially free form, and is not bound with grain components or other components that would tend to add flavor or color to the fermentation. The enzyme should be added in an amount sufficient to prevent the release of fermentable carbohydrate from the starch hydrolyzate from becoming rate limiting, or, conversely, from becoming so great as to cause sugar stressing of the yeast. Generally, the enzyme should be present in a sufficient amount to cause the percentage of fermentable carbohydrate in the fermentation mixture to remain at a level ranging from about 2% to about 5% by weight, based on the weight of the fermentation liquid, throughout most of the fermentation (at the end of the fermentation it is preferred that all dextrose be consumed by the yeast). Preferably the fermentable carbohydrate remains at this level though at least 90% of the fermentation time. To create a sweeter product, excess carbohydrate may be employed in the fermentation, and additional enzyme can be added (ideally after reaching an inactivating alcohol concentration) to create a higher sugar content in the fermentation product.

In practice, the relative amounts of each component of the fermentation reaction of the inventive method are selected to optimize the reaction for a fermented beverage having characteristics predetermined by the practitioner. The particular enzyme and starch hydrolyzate, as well as the amounts of enzyme and starch hydrolyzate, are selected such that the amount of fermentable carbohydrate released does not reach levels that stress yeast cells, as is understood in the art. Accordingly, the inventive method can comprise selecting the fermentation conditions and ingredients, including without limitation the amounts of starch hydrolyzate, yeast, nitrogenous yeast nutrient source, and enzyme, that are sufficient to sustain fermentation of the starch hydrolyzate to an inactivating alcohol concentration with minimal sugar- and nitrogen-related yeast cell stress. The parameters are preferably selected to minimize the amount of fusel oils, organic acids, and salts in the final product.

Fermentation is conducted under any suitable conditions that allow the enzyme to function, and are suitable for sustaining yeast and promoting fermentation of carbohydrates. For example, the fermentation can be performed at about 80° F. to about 98° F. for about 30 hours to about 48 hours, preferably in a closed vessel. No aging of the fermentation product is required (or desired in most embodiments). Preferably, no secondary fermentation step is employed. Fermentation preferably is conducted until the carbohydrate has been consumed, which, in preferred embodiments of the invention, will be at an alcohol concentration that is within 1% (absolute) of the inactivating alcohol concentration. In alternative embodiments, less carbohydrate amounts may be employed (thereby causing the reaction to terminate at a lower alcohol concentration), greater amounts of carbohydrate may be employed (thereby causing the reaction to terminate at the inactivating alcohol concentration and leaving carbohydrate in the product), or the reaction may be otherwise caused to terminate at an alcohol concentration that is less than the inactivating alcohol concentration.

The product of fermentation will be an alcoholic beverage, which may be referred to as a “fermentation beer.” The fermented beverage thus prepared is deemed to be a satisfactory and valuable commercial product. After fermentation, the yeast is removed from the fermentation beer using any suitable technique, such as centrifugation or filtration. While it is desirable to completely remove all yeast from the fermentation beer, this is not required. Additional rounds of filtration or other treatments can be employed to reduce the amount of yeast in the final fermented beverage.

If desired, the sediment-free fermentation beer can then be treated to reduce volatile and yeast-based contaminants or impurities which compromise flavor in the fermented beverage (e.g., acetaldehyde, methanol, propanol, and iso-amyl or iso-butyl alcohols). In one embodiment, the fermentation beer is treated with carbon (about 0.1% to about 3.0% (w/v)) to remove, for example, yeast-based impurities. Preferably, the inventive method comprises treating the fermentation beer with 1.5% carbon (w/v) for approximately 10 minutes to approximately 30 minutes to remove color and yeast-based flavor from the fermentation beer. The carbon is removed from the fermentation beer by conventional means, such as centrifuge or filtration. It will be appreciated that removal of all yeast-based contaminants is not required to create a fermented beverage with neutral flavor and color. By “substantially removing” contaminants is meant that a sufficient amount of contaminants are removed to provide a substantially flavor- and color-neutral fermented beverage.

To further remove impurities that affect flavor and color of the fermented beverage, the inventive method can further comprise substantially removing salts and organic acids which compromise flavor of the fermented beverage. In one embodiment, the salts and organic acids are removed by ion exchange treatment (e.g., cation-anion exchange filtration) of the fermented beverage (see, for example, European Patent 1,270,071, which discloses ion exchange treatment). Suitable ion exchange resins include, but are not limited to, strong acid and weak base resins. It will be appreciated that salts and organic acids need not be completely removed from the fermented beverage, but should not compromise the flavor or aroma of the fermented beverage. An additional carbon treatment can be performed to remove any flavor components introduced into the fermentation beer by the ion exchange filtration. It is contemplated that such treatments may reduce the alcohol content of the fermented beverage by dilution and/or elimination of ethanol.

In some embodiments, the invention contemplates selecting an amount of a calcium precipitated fermented beverage, selecting an amount of the starch hydrolyzate fermented beverage, and blending the beverages together in the desired amount. The invention contemplates the preparation of one or both of the fermented beverages that are then blended, or alternatively the blending of previously prepared beverages.

The blending may be done before or after treatment with carbon and/or an exchange resin, and blending may be done before or after color additives or flavor additives are added. The blended beverage thus provided can be diluted to reduce alcohol content, can be blended with distilled spirits, and otherwise can be used for the purposes heretofore described. The calcium precipitated fermented beverage and the starch hydrolyzate fermented beverage may be blended with one another in any suitable relative amounts. For instance, from 5 to 95%, preferably from 25% to 75%, of the alcohol content of the final fermented beverage may be contributed by the starch hydrolyzate fermented beverage, with the remainder based on the calcium precipitated fermented beverage (based on the total alcohol contributed collectively by the starch hydrolyzate fermented beverage and calcium precipitated fermented beverage and excluding alcohol contributed from other sources). For instance, the percentage of alcohol contributed by the starch hydrolyzate fermented beverage may be 5%, 10%, 15%, 20%, 25%, 30%, 35%, 40%, 45%, 50%, 55%, 60%, 65%, 70%, 75%, 80%, 85%, 90%, or 95% of the total alcohol contributed by the two beverages.

The invention further provides a fermented beverage produced in accordance with the inventive method described herein The fermented beverage is not distilled, yet embodies the desirable characteristics of flavor-neutral distilled spirits, namely the absence of flavor, aroma, and color, and, in highly preferred embodiments, the absence of perceptible residual carbohydrates or “body.” The color of the beverage may be evaluated via any suitable method. Preferably, the beverage is as colorless as possible. The beverage preferably is at least substantially free of sulfur flavors and odors, and is at least substantially free of other components that contribute to flavor and odor (e.g., diacetyl and esters).

It is contemplated that the final beverage may be provided and marketed in various embodiments as a flavorless malt beverage, a flavored drink, a wine cooler, or in any other suitable form. If desired, the beverage may be distilled. The calcium-precipitated fermented beverage or blended fermented beverage can be further processed to add flavorings or increase or decrease alcohol content. For example, flavor additives, such as citrus flavors or sugars, or color additives, such as food coloring, can be added to a fermented beverage blend that has been prepared in accordance with the foregoing teachings. The fermented beverage blend can be diluted (where appropriate and when the beverage possesses a higher alcohol content then desired) to reduce alcohol content, e.g., to achieve an alcohol content of about 4% to about 6%. In some embodiments the blend is prepared from starch hydrolyzate fermented beverage and calcium-precipitated fermented beverages that have a desired alcohol content (e.g. 4-6%) and no dilution will be necessary. The fermented beverage blend also can be blended with distilled spirits, such as distilled grain spirits, to yield an alcoholic beverage. In such blends, the fermented beverage blend can account for any desired percent of the alcohol content of the alcoholic beverage. In some embodiments, for instance, the alcohol contributed by the fermented beverage blend accounts for about 25% to about 75% (e.g. about 40% to about 60%) of the alcohol content of the alcoholic beverage. In other embodiments, the fermented beverage blend accounts for a higher percentage of the alcohol content, such as 80%, 85%, 90%, 95%, or 98% of the alcohol content. Some alcoholic beverages are prepared using flavoring agents that comprise distilled alcoholic solutions of flavor extracts (e.g. vanilla, lemon, or peppermint extract) or that otherwise are alcoholic. If such flavoring agents are used, these agents may contribute to the alcohol content of the alcoholic beverage, although the primary intent of adding such flavorings is not to increase the alcohol content.

The following examples further illustrate the invention but should not be construed as in any way limiting its scope.

### EXAMPLE 1

This example provides a method of producing starch hydrolyzate fermented beverage.

A fermentation reaction was performed using 230 g of a 10 DE maltodextrin and 10 g of soluble nitrogenous yeast nutrient source in a volume of 1.0 L. Approximately 35 ml to 70 ml of yeast propagation (i.e., yeast aerobically grown for 16 hours to 24 hours in medium similar to the fermentation broth) was added. Approximately 3.0 ml glucoamylase (50 units/ml) was provided to release fermentable carbohydrates from the maltodextrin. Fermentation was allowed to proceed anaerobically with minimal agitation at 90° F. for about 30 to about 48 hours to produce a fermentation beer with an alcohol content of 14% (slightly less than the 14.5% inactivating alcohol concentration for the species of baker's yeast that was employed).

The fermentation beer was centrifuged to remove yeast, and subsequently treated with carbon (4 g carbon per 200 ml fermentation beer) for 10 minutes at ambient temperature while stirring. The carbon was removed from the fermentation beer by filtration through Whatman #1 filter paper. The fermentation beer was then subjected to further treatment by adding approximately 20 g mixed bed ion exchange resin in the hydrogen and free base form per 200 ml fermentation beer. The ion exchange resin was stirred in the fermentation beer for approximately 10 minutes, and removed via filtration through Whatman #1 filter paper. A final carbon treatment (1.5 g carbon per 200 ml fermentation beer) was performed at room temperature for 10 minutes while stirring. The carbon was removed via filtration through Whatman #1 paper. The final alcoholic beverage had an alcohol content of about 12% (the alcohol content had been reduced slightly upon carbon treatment and ion-exchange treatment).

Evaluation of the resulted fermented beverage was performed by trained sensory professionals. The sensory panel classified the fermented beverage as “very clean” with no aftertaste. This example confirms the ability of the inventive method to produce a non-distilled, taste- and color-neutral fermented beverage.

### EXAMPLE 2

In this example, the starch hydrolyzate fermented beverage prepared in accordance with one embodiment of the invention was evaluated against grain neutral spirits in a mixed drink.

A fermented beverage was prepared in a manner essentially identical to that of the beverage prepared in accordance with Example 1. A panel of adult volunteers was selected for the test. Candidates for the panel initially were screened for the four main senses, salt, sweet, sour, and bitter. Three people were eliminated for apparent taste blindness to bitter and/or sour tastes. The resulting panel consisted of fifteen women and thirteen men. The panelists were assigned random numbers for participation in the panel.

A forced-choice, “triangle test for similarity” was conducted. Each panelist was presented with three mixed drinks and asked to determine which of the drinks was different. Sample A was 50% v/v of store-bought SPRITE™ that was vacuum-filtered to remove carbonation, approximately 6% v/v grain neutral spirits (GNS), and about 44% v/v reverse osmosis water. Sample B was 50% v/v store-bought SPRITE™ that was vacuum-filtered to remove carbonation, and 50% v/v of the fermented beverage prepared in accordance with the invention (FB). The fermented beverage had an alcohol content of about 12%.

The panelists were given a numbered tray with samples labeled 1, 2, and 3 and were instructed to smell and taste the samples in order. The panelists were then to identify which sample was not the same as the other. Testing was done on Tuesday and Thursday mornings, with no eating or drinking one hour before the test.

The six different random possibilities of sample order presentation were as follows:

| 1 | 2 | 3 |
|---|---|---|
| A | A | B |
| A | B | A |
| A | B | B |
| B | A | A |
| B | A | B |
| B | B | A |

Twenty trays per day were put out for testing. Panelists were assigned a “1” for a correct choice and a “0” for an incorrect choice. The following table summarizes the test results.

| Order | | | | | Correct | | % | | % |
|---|---|---|---|---|---|---|---|---|---|
| Values | #1 | #2 | #3 | different | choice | tests | correct | different | correct |
| 1 | A | A | B | #3 | 5 | 11 | 45.5 | #1 | 40.0 |
| 2 | A | B | A | #2 | 4 | 15 | 26.7 | #2 | 25.9 |
| 3 | A | B | B | #1 | 6 | 13 | 46.2 | #3 | 52.2 |
| 4 | B | B | A | #3 | 7 | 12 | 58.3 | | |
| 5 | B | A | B | #2 | 3 | 12 | 25.0 | | |
| 6 | B | A | A | #1 | 4 | 12 | 33.3 | | |
| | | | | Totals | 29 | 75 | 38.7 | | |

Using an upper one-tailed confidence interval statistical analysis, as described in Meilgaard, M., G. V. Civille, and B. T. Carr, Sensory Evaluation Techniques, CRC Press, Inc., Boca Raton, Fla. (1987) at Table T11 pg. 342, the hypothesis that “25% or less of the population will detect a difference in samples” was tested. This hypothesis was found to have succeeded at a 90% confidence level. The fermented beverage was deemed to be a suitable replacement for the diluted grain neutral spirits.

### EXAMPLE 3

A fermented distillery mash obtained from Grain Processing Corporation of Muscatine, Iowa was treated in the manner described hereinabove to prepare a calcium-precipitated fermented beverage. This resulting beverage was clear, colorless, and devoid of sulfurous odor and flavor as determined by trained organoleptic personnel.

### EXAMPLE 4

A fermented distillery mash is treated with calcium in the manner described hereinabove to prepare a calcium-precipitated fermented beverage. This beverage is decolorized with carbon, subjected to ion exchange treatment in the manner heretofore described, and blended with the fermented beverage prepared in accordance with Example 1 in the amounts of 25% calcium precipitated fermented beverage/75% starch hydrolyzate fermented beverage (based on the total alcohol content contributed by the two beverages).

### EXAMPLE 5

Example 4 is repeated, except that an alcoholic vanilla extract is added to impart the fermented beverage with a vanilla flavor. The relative amounts of calcium precipitated fermented beverage and starch hydrolyzate fermented beverage remain 25%/75%, even though additional alcohol has been added.

### EXAMPLE 6

Example 4 is repeated, except that the relative amounts of the two beverages are 75% calcium precipitated fermented beverage/25% starch hydrolyzate fermented beverage.

### EXAMPLE 7

A fermented distillery mash is treated with calcium to form a calcium-precipitated fermented beverage in the manner heretofore described. This beverage is blended with the fermentation beer prepared in accordance with Example 1 (prior to treatment with carbon). The relative amounts of calcium-treated fermented beverage and starch hydrolyzate fermented beverage are 75%/25% based on the total alcohol content contributed by the two beverages. The fermentation blended beverage thus prepared is subjected to carbon treatment and ion exchange treatment as further described in Example 1.

### EXAMPLE 8

Example 7 is repeated, except that sugar and an alcoholic extract of vanilla are added to impart the blended beverage with a sweet vanilla flavor.

It is thus seen that the invention provides a neutral alcoholic beverage. In some embodiments, the invention provides an alcoholic beverage by adding flavor or color components to a neutral beverage that has been prepared in accordance with the foregoing teachings.

All references cited herein are hereby incorporated by reference. The teachings of co-pending application Ser. No. 10/803,348 as pertain to the preparation of a starch hydrolyzate fermented beverage are incorporated by reference in their entireties.

All methods described herein can be performed in any suitable order unless otherwise indicated herein or otherwise clearly contradicted by context. The use of any and all examples or exemplary language provided herein is intended merely to better illuminate the invention and does not pose a limitation on the scope of the invention unless otherwise claimed. No language in the specification should be construed as indicating any non-claimed element as essential to the practice of the invention. Alcohol contents described herein are expressed on a percent by volume basis. Percentages expressed on a weight per volume (w/v) basis signify an amount equivalent to adding water to the weight in grams to yield 100 ml total volume.

Preferred embodiments of this invention are described herein, including the best mode known to the inventors for carrying out the invention. Variations of those preferred embodiments may become apparent to those of ordinary skill in the art upon reading the foregoing description. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for preparing an alcoholic beverage, comprising:
providing an alcoholic mixture, said alcoholic mixture comprising the product of fermentation of a fermentable material, said alcoholic mixture including sulfurous proteinaceous material;
treating said alcoholic mixture with calcium under conditions suitable to precipitate at least a portion of said sulfurous proteinaceous material; and
separating said precipitated proteinaceous material from the remainder of said alcoholic mixture thereby yielding an alcohol beverage.

2. A method according to claim 1, comprising adding calcium hydroxide to said fermented beverage, the pH of said fermented beverage after calcium hydroxide addition ranging from pH 5 to pH 8.

3. A method according to claim 2, said pH ranging from 6.0 to 6.5.

4. A method according to claim 1, further comprising treating said alcoholic beverage with an amount of carbon effective to at least substantially decolor said alcoholic beverage thereby yielding a decolored beverage.

5. A method according to claim 4, further comprising treating said decolored beverage with an ion exchange material to reduce the level of at least one undesirable component, said undesirable component being selected from the group consisting of ash, flavor components, color components, organic acids, and mixtures thereof.

6. A method according to claim 1, said fermented mixture comprising distiller's corn mash.

7. A method according to claim 1, said proteinaceous material being separated via centrifugation.

8. A method according to claim 1, said proteinaceous material being separated via filtration.

9. A method according to claim 1, further comprising adding a flavoring agent to said alcoholic beverage.

10. A method according to claim 9, said flavoring agent comprising a sweetener.

11. A method according to claim 4, further comprising adding a flavoring agent to said alcoholic beverage.

12. A method according to claim 5, further comprising adding a flavoring agent to said alcoholic beverage.

13. An alcoholic beverage prepared in accordance with claim 1.

14. An alcoholic beverage prepared in accordance with claim 4.

15. An alcoholic beverage prepared in accordance with claim 5.

16. An alcoholic beverage prepared in accordance with claim 9.

17. A method for preparing an alcoholic beverage, comprising:
providing a fermentable material;
fermenting said fermentable material to thereby form an alcoholic mixture, said alcoholic mixture including sulfurous proteinaceous material;
treating said alcoholic mixture with calcium under conditions suitable to precipitate at least a portion of said sulfurous proteinaceous material; and
separating said precipitated proteinaceous material from the remainder of said alcoholic mixture thereby yielding an alcoholic beverage.

18. A method according to claim 17, said alcoholic mixture having an alcohol content ranging from 8 to 18%.

19. A method according to claim 17, comprising adding calcium hydroxide to said fermented beverage, the pH of said fermented beverage after calcium hydroxide addition ranging from pH 5 to pH 8.

20. A method according to claim 19, said pH ranging from 6.0 to 6.5.

21. A method according to claim 17, further comprising treating said alcoholic beverage with an amount of carbon effective to at least substantially decolor said alcoholic beverage thereby yielding a decolored beverage.

22. A method according to claim 21, further comprising treating said decolored beverage with an ion exchange material to reduce the level of at least one undesirable component, said undesirable component being selected from the group consisting of ash, flavor components, color components, organic acids, and mixtures thereof.

23. A method according to claim 17, said fermented mixture comprising distiller's corn mash.

24. A method according to claim 17, said proteinaceous material being separated via centrifugation.

25. A method according to claim 17, said proteinaceous material being separated via filtration.

26. A method according to claim 17, further comprising adding a flavoring agent to said alcoholic beverage.

27. A method according to claim 25, said flavoring agent comprising a sweetener.

28. A method according to claim 21, further comprising adding a flavoring agent to said alcoholic beverage.

29. A method according to claim 22, further comprising adding a flavoring agent to said alcoholic beverage.

30. An alcoholic beverage prepared in accordance with claim 17.

31. An alcoholic beverage prepared in accordance with claim 21.

32. An alcoholic beverage prepared in accordance with claim 22.

33. An alcoholic beverage prepared in accordance with claim 26.

34. A method for preparing a blended beverage, comprising:
providing a calcium-precipitated fermented beverage, said calcium-precipitated fermented beverage having been prepared by providing an alcoholic mixture, said alcoholic mixture comprising the product of fermentation of a fermentable material, said alcoholic mixture including sulfurous proteinaceous material; treating said alcoholic mixture with calcium under conditions suitable to precipitate at least a portion of said sulfurous proteinaceous material; and separating said precipitated proteinaceous material from the remainder of said alcoholic mixture thereby yielding a calcium precipitated alcoholic beverage;
providing a starch hydrolyzate fermented beverage, said starch hydrolyzate fermented beverage having been prepared by providing a starch hydrolyzate, said starch hydrolyzate consisting essentially of free glucose and saccharide oligomers, and, in the presence of yeast, a soluble nitrogenous yeast nutrient source, and an enzyme that releases fermentable carbohydrates from the starch hydrolyzate, allowing fermentable carbohydrates to be released from said starch hydrolyzate and allowing fermentation of said fermentable carbohydrates to proceed to yield a fermented beverage, wherein the soluble nitrogenous yeast nutrient source is more organoleptically neutral than corn steepwater and is present in an amount sufficient to sustain fermentation to an inactivating alcohol concentration in the fermented beverage without being rate limiting in the fermentation; and
blending said calcium-precipitated fermented beverage with said starch hydrolyzate fermented beverage.

35. A method according to claim 34, wherein the calcium-precipitated fermented beverage and said starch hydrolyzate fermented beverage are present in relative amounts ranging from 5% calcium-precipitated fermented beverage/95% starch hydrolyzate fermented beverage to 95% calcium-precipitated fermented beverage/5% starch hydrolyzate fermented beverage, based on the total alcohol content contributed by said calcium precipitated fermented beverage and said starch hydrolyzate fermented beverage.

36. A method according to claim 35, the starch hydrolyzate fermented beverage being present in a relative amount ranging from 25% to 75%.

37. A method according to claim 34, wherein said calcium precipitated fermented beverage and said starch hydrolyzate fermented beverage each have been treated prior to blending with carbon in an amount effective to at least substantially decolor said beverages.

38. A method according to claim 34, the method further comprising treating said blended beverage subsequent to blending with carbon in an amount effective to at least substantially decolor said blended beverage.

39. A method according to claim 34, wherein each of said calcium precipitated fermented beverage and said starch hydrolyzate fermented beverage has been treated prior to blending with an ion exchange material to reduce the level of at least one undesirable component, said undesirable component being selected from the group consisting of ash, flavor components, color components, organic acids, and mixtures thereof.

40. A method according to claim 34, further comprising treating said blended beverage subsequent to blending with an ion exchange material to reduce the level of one undesirable component, said undesirable component being selected from the group consisting of ash, flavor components, color components, organic acids, and mixtures thereof.

41. A method according to claim 34, said starch hydrolyzate being selected from the group consisting of a maltodextrin and a syrup solid.

42. A method according to claim 34, said calcium precipitated fermented beverage being derived from distiller's corn mash.

43. A method according to claim 34, said starch hydrolyzate being selected from the group consisting of a maltodextrin and a syrup solid, said calcium precipitated fermented beverage being derived from distiller's corn mash.

44. A method according to claim 34, further comprising preparing said starch hydrolyzate fermented beverage.

45. A method according to claim 34, further comprising preparing said calcium precipitated fermented beverage.

46. A beverage prepared in accordance with claim 34.

47. A beverage prepared in accordance with claim 43.
